(19) United States
(12) Patent Application Publication
(10) Pub. No.: US 2016/0103543 A1
(43) Pub. Date: Apr. 14, 2016

(54) Force Sensor with Capacitive Gap Sensing

(71) Applicant: Apple Inc., Cupertino, CA (US)

(72) Inventors: Patrick Kessler, San Francisco, CA (US); Jonah A. Harley, Cupertino, CA (US); Soyoung Kim, Cupertino, CA (US); Daniel D. Sunshine, Cupertino, CA (US)

(21) Appl. No.: 14/972,048

(22) Filed: Dec. 16, 2015

Related U.S. Application Data
(63) Continuation of application No. 14/501,384, filed on Sep. 30, 2014.
(60) Provisional application No. 62/043,077, filed on Aug. 28, 2014.

(51) Int. Cl. G06F 3/041; G06F 3/044

(52) U.S. Cl. CPC G06F 3/0414; G06F 3/044; G06F 2203/04104; G06F 2203/04105

(57) ABSTRACT

A force sensor and force-sensing structure for use as input to an electronic device. A user touch event may be sensed on a display, enclosure, or other surface associated with an electronic device using a force sensor adapted to determine the magnitude of force of the touch event. The sensor output, corresponding to the magnitude of force, may be used as an input signal, input data, or other input information to the electronic device. A force sensor may include an array of upper electrodes disposed on a first substrate and a compliant medium disposed in a gap between the first substrate and a second substrate. At least one lower electrode may be disposed on the second substrate. The first substrate may be configured to deflect relative to the second substrate over a localized region when a force is applied to the force-receiving surface.

### CROSS-REFERENCE FOR RELATED APPLICATION

This application claims the benefit under 35 U.S.C. §119(e) of U.S. Provisional Patent Application No. 62/043,077, filed on Aug. 28, 2014, and entitled “Force Sensor with Capacitive Gap Sensing,” which is incorporated by reference as if fully disclosed herein.

### TECHNICAL FIELD

Embodiments described herein generally relate to a force sensor integrated into a device and, more particularly, to detecting the location and magnitude of the force of a touch using a capacitive gap sensor.

### BACKGROUND

Some electronic devices include a touch sensitive surface for receiving input from a user. Some traditional touch devices are able to detect the presence or even the location of a touch on an external surface. In order to detect the touch one or more sensor electrodes are typically placed proximate to the touch sensitive surface. However, many traditional touch devices are unable to detect or measure the magnitude of the force of a touch on the device. Thus, the output provided by some traditional touch sensor, like many present inputs for computing devices, is binary. That is, the touch is present or it is not. Binary inputs are inherently limited insofar as they can only occupy two states (present or absent, on or off, and so on).

In many examples, it may be advantageous to also detect and measure the force of a touch that is applied to a surface. In addition, if the force can be measured across a continuum of values, it can function as a non-binary input. Further, the combination of touch input and force input may provide certain advantages over the use of either alone.

Accordingly, there may be a present need for an improved input surface capable to detect and relay the force applied at one or more user touch locations.

### SUMMARY

Embodiments described herein may relate to, include, or take the form of a force sensor and force-sensing structure for use as input to an electronic device. In general, a user touch event may be sensed on a display, enclosure, or other surface associated with an electronic device using a force sensor adapted to determine the magnitude of force of the touch event. The sensor output, corresponding to the magnitude of force, may be used as an input signal, input data, or other input information to the electronic device.

One example embodiment is directed to an electronic device having a force sensor. The force sensor includes a force-receiving surface on an exterior surface of an electronic device. A first substrate may be disposed below the force-receiving surface and an array of upper electrodes may be disposed on the first substrate. The sensor also includes a compliant medium disposed in a gap between the first substrate and a second substrate. The second substrate is separated from the first substrate by the gap. At least one lower electrode may be disposed on the second substrate. In some cases, the first substrate is configured to deflect relative to the second substrate over a localized region when a force is applied to the force-receiving surface.

The sensor may also include capacitive monitoring circuitry that is operatively connected to the array of upper electrodes and the at least one lower electrode. The capacitive monitoring circuitry may be configured to detect and measure changes in the capacitance between an upper electrode and the at least one lower electrode. The circuitry may also be configured to produce an output that can be used to compute an estimated force applied to the force-receiving surface.

In some embodiments, the second substrate is configured to deflect when a force is applied to the force-receiving surface. In some cases, the gap between the first substrate and the second substrate may remain substantially uniform over a region away from the localized region when the force is applied to the force-receiving surface. The compliant medium may displace within the localized region to allow the first substrate to deflect relative to the second substrate.

In some instances, the first substrate, the second substrate, and the compliant medium are suspended from a component that is coupled to the force-receiving surface. In one example, the second substrate attached to the device via the compliant medium and the first substrate, wherein the second substrate is not substantially supported by a component other than the compliant medium and the second substrate.

In one example embodiment, a display may be disposed between the first substrate and the force receiving surface. The first substrate may be coupled to a lower surface of the display. In some cases, the display is attached to a housing of the electronic device, and the first substrate is attached to the display and is not substantially supported by a component other than display.

In another example embodiment, the display may be disposed below the second substrate. The first substrate and the second substrate may be formed from transparent materials and the compliant medium may have an index that is substantially matched to an index of the first and second substrates. In some cases, the first and second substrates are formed from a glass material. The compliant medium may include a silicone gel and/or a liquid medium. The compliant medium may include, for example, a polyethylene glycol liquid material.

In some embodiments, the array of first electrodes may include an upper array of pixel electrodes having a substantially rectangular shape, and the at least one second electrode is part of a lower array of pixel electrodes having a substantially rectangular shape. In other embodiments, the array of first electrodes may include an upper array of row electrodes extending along a first direction, and the at least one second electrode is part of a lower array of column electrodes extending along a second direction transverse to the first direction.

One example embodiment is directed to a force sensor including an array of upper electrodes disposed on a surface within the electronic device and a compliant medium disposed in a gap between the array of upper electrodes and a second substrate. In some cases, the surface is the lower surface of a display element. In some cases, the surface is an interior surface of a housing of the electronic device. The second substrate may be separated from the surface by the gap and at least one lower electrode may be disposed on the second substrate. The first surface may be configured to deflect relative to the second substrate over a localized region when a force is applied to the force-receiving surface.

### BRIEF DESCRIPTION OF THE DRAWINGS

Reference will now be made to representative embodiments illustrated in the accompanying figures. It should be understood that the following descriptions are not intended to limit the embodiments to one preferred embodiment. To the contrary, it is intended to cover alternatives, modifications, and equivalents as may be included within the spirit and scope of the described embodiments as defined by the appended claims.

FIG. 1 depicts an example electronic device incorporating at least one transparent force sensor.

FIG. 2A depicts a cross-sectional view of the device of FIG. 1 having a first example force-sensitive structure taken along section A-A.

FIG. 2B depicts a cross-sectional view of the device of FIG. 1 having a second example force-sensitive structure taken along section A-A.

FIG. 2C depicts a cross-sectional view of the device of FIG. 1 having a third example force-sensitive structure taken along section A-A.

FIG. 2D depicts a cross-sectional view of the device of FIG. 1 having a fourth example force-sensitive structure taken along section A-A.

FIG. 3A depicts an example array of electrode disposed on a substrate.

FIG. 3B depicts an alternative example of an array of electrodes disposed on a substrate.

FIG. 4A depicts an example deflection of a first and second substrate in an example force-sensitive structure.

FIG. 4B depicts an example output of a force-sensitive structure.

FIG. 4C depicts an example deflection of a first and second substrate in an example force-sensitive structure.

FIG. 4D depicts an example output of a force-sensitive structure.

FIG. 5A depicts an example process for detecting a touch using a force-sensitive structure.

FIG. 5B depicts an example method of manufacturing a force-sensitive structure.

The use of the same or similar reference numerals in different figures indicates similar, related, or identical items.

### DETAILED DESCRIPTION

Embodiments described herein relate to or take the form of force sensors or force-sensitive structures for receiving user input to an electronic device. In some examples discussed herein, a force sensor having a force-sensitive structure may be used to detect and measure the force of more than one simultaneous touch on a surface of the device. In particular, the force-sensitive structure may be used to estimate the force of multiple individual touches that are simultaneously or contemporaneously touching the surface of the device. In some embodiments, the force-sensitive structure may provide both the location of a touch and the magnitude of a touch using a force-sensitive structure. Additionally or alternatively, a force-sensitive structure may be used in conjunction with a separate touch sensor to determine the location and magnitude of a touch or multiple touches on the surface of a device.

Generally, a user touch event may be sensed on a display, enclosure, or other surface associated with an electronic device using a force sensor adapted to determine the magnitude of force of the touch event. The sensor output, corresponding to the magnitude of force, may be used as an input signal, input data, or other input information to the electronic device. In particular, a high force input event may be interpreted differently from a low force input event. For example, an electronic device having a display may unlock the display screen when a high force input event is detected and may perform another function, such as pause audio output, when a low force input event is detected. The device's responses or outputs may thus differ in response to the two inputs, even though they occur at the same point and may use the same input device.

In further examples, the force associated with a touch may be interpreted as an additional type of input. For example, a user may provide non-binary or analog input to the device by varying the force of a touch on the surface. Generally, non-binary input may include, for example, a graduated input, stepped input, variable input, analog input, or other similar input to the device. It may be further advantageous to detect and measure the force associated with multiple, simultaneous touches on the surface of a device to enable multipoint non-binary touch input. Multipoint non-binary touch input may, for a given touch sensor, increase the number of inputs and the information that may be interpreted by the multiple inputs.

The force-sensing structures, in combination with other sensor circuitry, may be configured to detect and measure the force of multiple touches on the surface of a device. In some of the examples described below, the force-sensitive structures are formed from two substrates that are separated by a gel layer, or similar compliant or displaceable material, disposed between the substrates. One or both of the substrates include an array of electrodes disposed on a surface of the substrate and arranged in a pattern that substantially covers the surface of the substrate. The substrates, electrodes, and compliant layer may be referred to herein as a force-sensitive structure.

In some instances, the force-sensitive structure may be integrated into a device having a touch-sensitive surface. When a force is applied to the surface of the device, a first substrate may deflect relative to the second substrate. For example, a compliant or displaceable gel layer that is disposed in a gap between the two substrates, may allow the first substrate to deflect relative to the second substrate over a localized region of the surface near the touch. Additionally, the compliant gel layer may partially distribute the force or load between the two substrates resulting in the two substrates deflecting or bowing together over a portion of the surface that may be much larger relative to the localized portion. The magnitude of the force may be determined by measuring the change in capacitance between electrodes that disposed on either side of the gap. In particular, by comparing the relative change in capacitance between electrodes located near the touch (near the localized region of deflection) and electrodes that are located away from the touch, a magnitude of the force of the touch may be computed. Additionally or alternatively, a location of the touch may also be computed by comparing the relative change in capacitance.

In some embodiments, multiple simultaneous touches may be detected using the force-sensitive structure. For example, a second touch on the surface of the device may cause a second localized deflection of the first substrate relative to the second substrate, which may similarly be detected by measuring the relative change in capacitance. In some embodiments, the location and the force of multiple, contemporaneous touches on a device may be determined using the force-sensitive structure. Also, as discussed above, the output of a force-sensitive structure may be combined with another touch sensor that is configured to determine the location of a touch.

In some implementations, the capacitance between the electrodes may be monitored and measured using capacitive monitoring circuitry that is operatively coupled to the electrodes of the force-sensitive structure. For example, capacitive monitoring circuitry may be configured to scan or poll individual electrode pairs and produce an output that corresponds to the capacitance. A force-sensitive structure that is operatively coupled to capacitive monitoring circuitry may be referred to herein as a force sensor or touch sensor.

One or more force-sensitive structures may be integrated into an electronic device to provide a touch-sensitive surface. In some cases, the force-sensitive structures may be formed from transparent materials and disposed over a display or other visual output of an electronic device. In other cases, the force-sensitive structures may be formed, at least in part, from non-transparent materials and may be disposed below a display or other non-transparent surface of an electronic device. The electronic device may be, for example, a mobile phone, a tablet computing device, a computer display, a computing input device (e.g., a touch pad, keyboard, or mouse), a wearable device, a health monitor device, a sports accessory device, and so on.

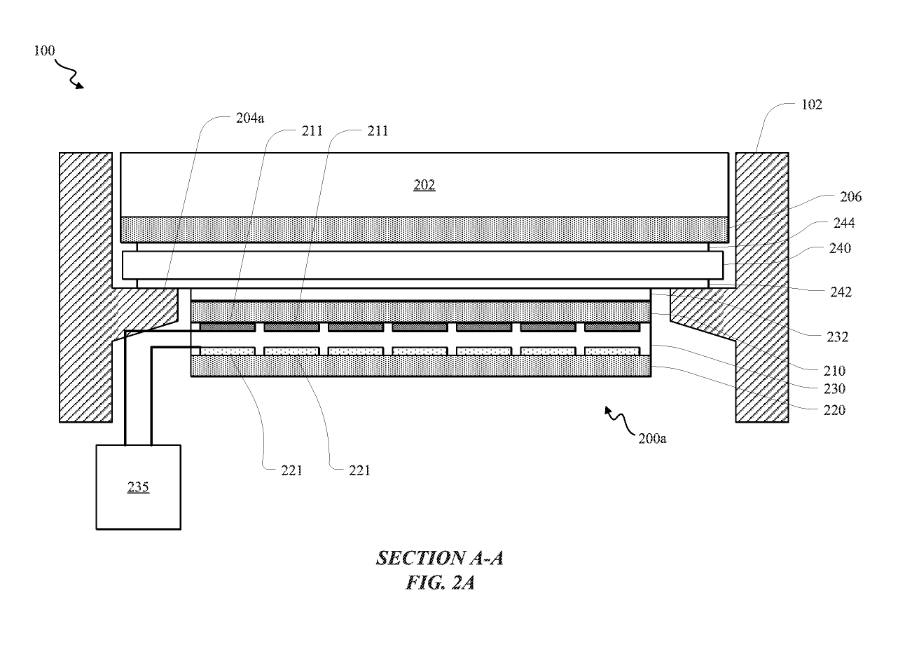

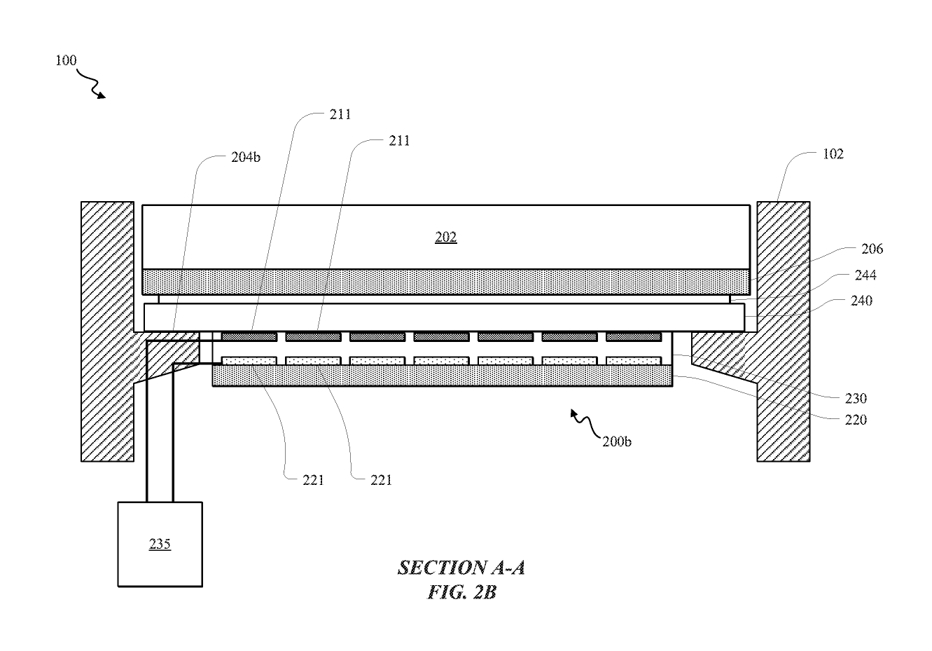

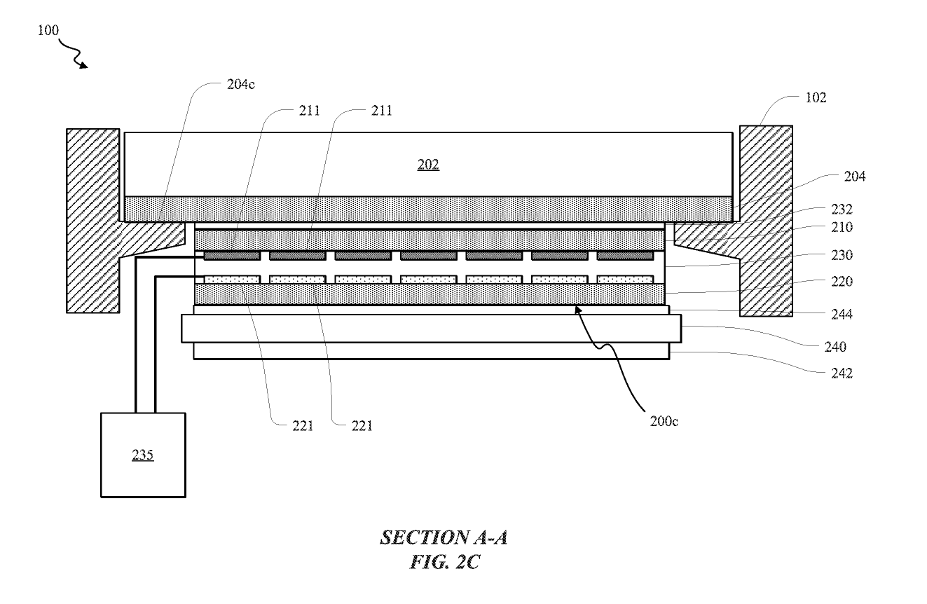

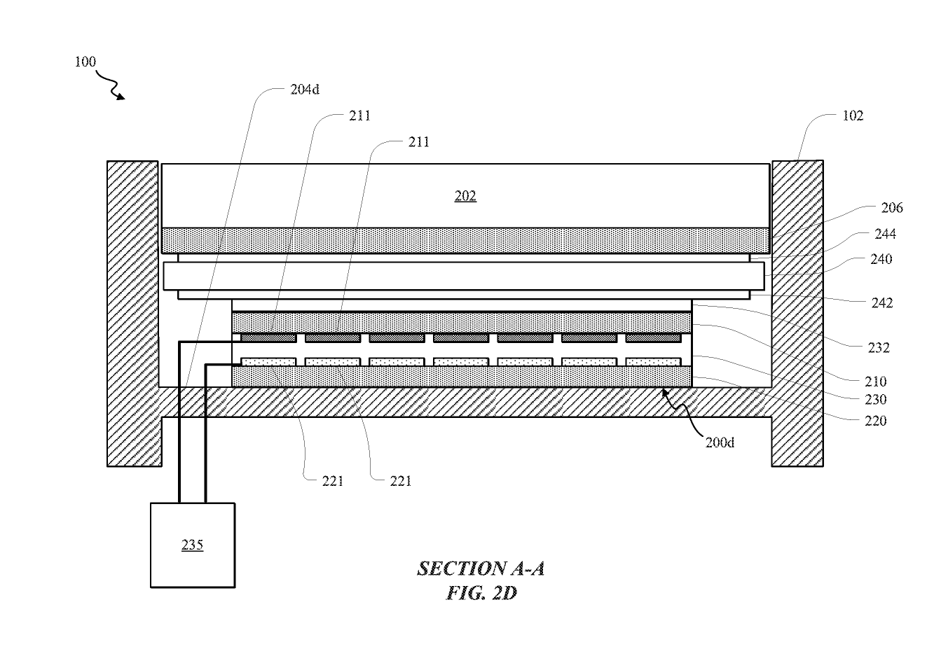

In one example, one or more force-sensitive components may be integrated with or attached to a display element of a device, which may include other types of sensors. In one example embodiment, a display element may also be integrated with a touch sensor configured to detect the location of one or more user touch events. In certain embodiments, the force-sensitive component may be integrated with, or placed adjacent to, portions of a display element, herein generally referred to as a “display stack” or simply a “stack.” A force-sensitive component may be integrated with a display stack, by, for example, being attached to a substrate or sheet that is attached to the display stack. In some cases, the force of a touch may deflect or bend the display stack, which in turn deflects or bends a portion of the force-sensitive structure. A few example embodiments are described below with respect to FIG. 2A-D. Although certain examples are herein provided with respect to force-sensitive component integrated with a display stack, in other embodiments, the force-sensitive component may be integrated in a portion of the device other than the display stack.

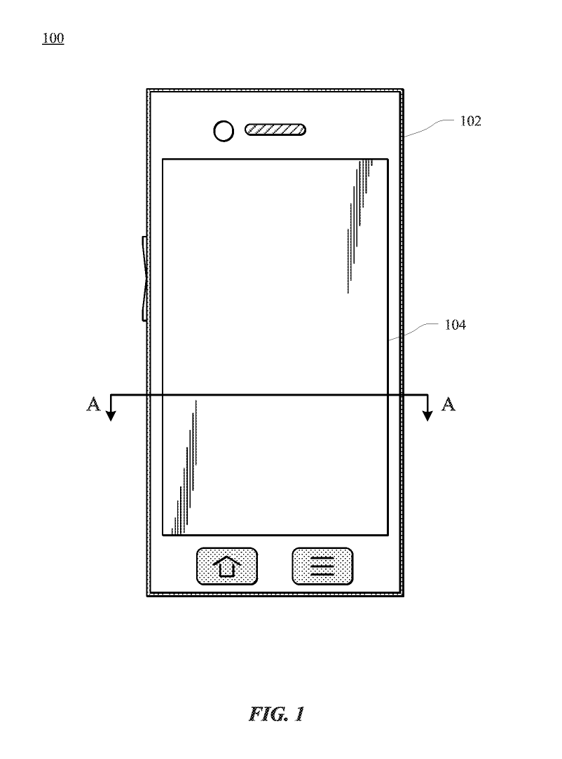

FIG. 1 depicts an example electronic device 100 incorporating at least one force-sensitive structure. As shown in FIG. 1, the electronic device 100 includes a display 104 disposed within a housing 102. The display 104 may be any suitable display element configured to produce a visual output to a user. Example displays include, without limitation, liquid crystal display (LCD), organic light emitting diode display (OLED), light emitting diode display (LED), and the like. The display 104 may be integrated with additional components or layers including, for example, a cover glass layer, a touch sensor layer, and so on. Additionally, the display stack may include a touch sensor for determining the location of one or more touches on the display 104 of the electronic device 100. As described in more detail below with respect to FIGS. 2A-D, a force-sensitive structure may be integrated with or attached to the display 104 or one of the layers integrated with the display 104. Alternatively or additionally, a force-sensitive structure may be integrated with another surface of the device that is not associated with the display of a device. For example, one or more force-sensitive structures may be integrated with a surface of the housing 102 or other surface of the device.

FIGS. 2A-D depict cross-sectional views of different embodiments of a force-sensitive structure integrated into the device 100 depicted in FIG. 1. The configurations depicted in FIGS. 2A-D are provided by way of example only and are not intended to limit the disclosure to the depicted embodiments. In particular, the number of components and arrangement of some of the components may vary with respect to the specific examples and still fall within the scope of the present disclosure. Additionally, the thickness and relative size of the various components depicted in the figured may be exaggerated to improve clarity and/or visibility of some components and may not necessarily represent the size of an actual construction or implementation.

FIG. 2A depicts a cross-sectional view of the device of FIG. 1 having a first example force-sensitive structure 200a taken along section A-A. In the example depicted in FIG. 2A, a display element 240 is integrated into the housing 102 using a mounting feature 104a, which may be formed as an integral part of the housing 102. The device 100 also includes a cover glass 202 which may be attached to or integrated with the display element 240. In this example, the force-sensing structure 200a is disposed below both the cover glass 202 and the display element 240.

In the example depicted in FIG. 2A, a force produced by a touch on the surface of the cover glass 202, may be transferred through the various layers to the force-sensitive structure 200a. In the present example, the force of a touch may cause the layers of the stack to deflect under the load in a predictable manner. The force may also cause a first substrate 210 of the force-sensitive structure 200a to deflect relative to a second substrate 220. In this example, the first and second substrates 210, 220 are separated by a gap that may be substantially filled with a compliant medium 230. The compliant medium 230 helps to maintain the gap between first and second substrates 210, 220. However, the compliant medium 230 is also configured to displace or flow to allow for localized deflection between the first and second substrates 210, 220. Thus, in some cases, a portion of the first substrate 210 that is near the force applied by the touch may deflect relative to the second substrate 220 over a localized region or area. The relative deflection over the localized region may be greater than the relative deflection between the substrates over other portions of the force-sensing structure 200a.

The relative deflection at various locations between the substrates may be detected and quantified by measuring the capacitance between corresponding upper electrodes 221 and lower electrodes 221. In particular, for a given force-sensing structure, the capacitance between electrode pairs may correspond to a distance or relative deflection between the substrates. By estimating the difference in the relative deflection between substrates at various locations within the force-sensing structure, a magnitude of the force may be computed or estimated. In some cases, the location of the touch may also be computed or estimated using the difference in the relative deflection between substrates.

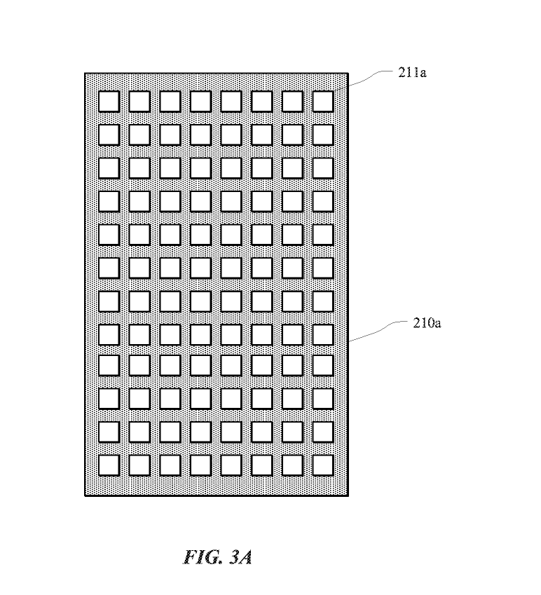

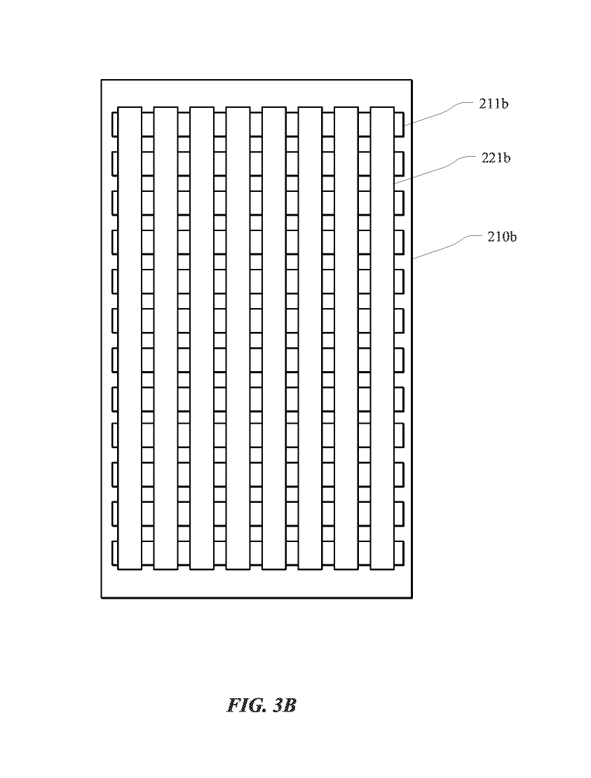

In this example, the electrodes are arranged in an array with each upper electrode 211 disposed above a corresponding lower electrode 221. An example capacitive measurement may include measuring the capacitance between an upper electrode that is disposed directly above a lower electrode. However a variety of electrode configurations may be used, as discussed below with respect to FIGS. 3A-B. In one alternative embodiment, the electrodes are formed as strips, the upper electrodes arranged in columns (or rows) and the lower electrodes arranged in rows (or columns). In this case, an example capacitive measurement may include measuring the mutual capacitance at an overlap of a row and column electrode. In another alternative embodiment, the upper electrodes are formed as an array of electrodes and the lower electrode may be a single large area electrode. In this case, an example capacitive measurement may include measuring the capacitance between an upper electrode of the array and the single lower electrode.

As shown in FIG. 2A, a compliant layer or medium 230 is also formed between the upper and lower electrodes 211, 221. As described above, the compliant medium 230 may include a silicone gel or other material that may displace when a force is applied directly or indirectly to the force-sensing structure 200a. In some cases, the compliant layer medium 230 includes an array soft structures, such as bump or column structures that are immersed in a gel or liquid medium. In one example, a polyethylene glycol or polyglycol liquid is used to substantially fill the remaining volume (or the entire volume) of the gap between the substrates. In some implementations, it may be beneficial to use a liquid having a low viscosity so that the force-sensitive structure is resilient and returns to a non-deflected state shortly after a force is removed.

In the present example, the force-sensitive structure 200a is disposed below a display stack mounted in the housing 102 of the device. As shown in FIG. 2A, the force-sensitive structure 200a is suspended below the display 240, which is attached to mounting feature 204a. In this example, the force-sensitive structure 200a, including the first substrate 210, compliant medium 230, and second substrate 220 are attached to the other display stack components via an pressure sensitive adhesive (PSA) layer 232. In this configuration, the first substrate 210 and the rest of the force-sensitive structure 200a is attached primarily to the display 240 and is not substantially supported by a component other than display 240. In this particular example, the force-sensitive structure 200a is attached to the display 240 via the PSA layer 232 and the rear polarizer 242.

This configuration may be advantageous for a number of reasons. For example, by suspending the force-sensitive structure 200a using, for example, the surface of the first substrate 210 to mount the structure, the sensing function of the force-sensitive structure 200a may be improved. In particular, by suspending the force-sensitive structure 200a from the deflecting surface, a localized deflection of the first substrate 210 with respect to the second substrate 210 may be more pronounced or readily detected. In some implementations, because the second (lower) substrate 220 is allowed to deflect, the second substrate 220 may deflect with the first substrate 210 over substantially the entire region of the structure, except for the localized region. This may result in a more pronounced difference between the deflection in the localized region as compared to (substantially uniform) deflection in the remainder of the structure. Additionally, if the deflection occurs near the edges of the force-sensitive structure 200a, the relative deflection of the two substrates may not be influenced by an edge or perimeter constraints. In some cases, suspending the structure may reduce or eliminate the occurrence of a false or phantom response due to edge constraints at the perimeter of the structure.

Additionally, suspending the force-sensitive structure 200a may allow for the installation of the force-sensitive structure 200a after the display 240 has been installed in the housing 102. This configuration may also allow for modification or service of the force-sensitive structure 200 without having to disturb the optical components of the display stack. Also, by disposing the force-sensitive structure 200 below the display 240, the components or elements of the force-sensitive structure to not need to be transparent.

As shown in FIG. 2A, the display 240 is attached to the housing 102 by mounting feature 104a. The display element 240 may include an LCD element, OLED element, LED element, and the like. In some cases the display element 240 also includes a backlight or light source layer. In the present example, the display element 240 is supported by the mounting feature 104a along the perimeter of the display element 240. A rear polarizer 242 or other layer(s) may be disposed between the display element 240 and the mounting feature 104a.

As shown in FIG. 2A, the device 100 includes a cover glass 202 forming part of the exterior surface of the device. Multiple layers may be disposed between the cover glass 202 and the display element 104. In this example, a polarizer layer 244 and a touch sensor layer 206 are disposed below the cover glass 202. The touch sensor layer 206 may include a self-capacitive or mutually-capacitive sensor that is configured to detect the location of a touch on the surface of the cover glass 202. The touch sensor layer 206 may include, for example, a laminate structure of transparent conductive electrodes formed on one or more transparent substrates. As previously suggested, the output of the touch sensor layer 206 may be combined with or used in conjunction with the output of the force-sensitive structure to determine both the location and force of one or more touches on the surface of the cover glass 202.

In the present example, capacitive sensing circuitry 235 is electrically coupled to the array of upper electrodes 211 and the array of lower electrodes 221. The capacitive sensing circuitry 235 may be configured to measure the capacitance of each upper and lower electrode pair of the force-sensing structure 200a. In one example, the capacitive sensing circuitry 235 is configured to produce a charge or voltage across the array of (upper or lower) electrodes using an alternating or pulsed electrical signal. The capacitive sensing circuitry 235 may be configured to detect changes in capacitance using a charge amplifier or other similar charge detecting circuity. The capacitive sensing circuitry 235 may also be configured to detect changes in capacitance by measuring the relative impedance of the electrode pairs.

The capacitive sensing circuitry 235 may scan each of the electrode pairs at a regular interval. In some embodiments, the capacitive sensing circuitry 235 may monitor fewer than all of the electrode pairs until a touch is detected to conserve power and computing resources. In some implementations, the capacitive sensing circuitry 235 may be scan or sample electrode pairs over a region or multiple regions that may be representative of portions of the full array. A variety of other electrode poling or scanning techniques may also be used.

In one example, the capacitive sensing circuitry 235 is configured to detect changes in capacitance at least one electrode pair near the location of the touch and at least one other electrode pair located away from the location of the touch. The capacitive sensing circuitry 235 may be further configured to produce a signal or output based on the difference between the change in capacitance of at least one electrode pair near the touch and at least one other electrode pair located away from the touch. In some cases, the output from the capacitive sensing circuitry 235 uses the relative difference in capacitance to compute or estimate the force of a touch on the device.

The capacitive sensing circuitry 235 may also be configured to detect and measure the force of multiple touches on the cover glass 202. In one example, the capacitive sensing circuitry 235 may be configured to scan the array of electrodes to collect capacitive measurements across the force-sensitive structure 200a. The capacitive sensing circuitry 235 may be further configured to detect one or more local maxima (or minima), which may represent one or more touches on the surface of the cover glass 202. The capacitive sensing circuitry 2356 may be configured to produce an output representative of the force of each of the one or more touches, which may facilitate multi-point force sensing capability.

FIG. 2B depicts a cross-sectional view of the device of FIG. 1 having a second example force-sensitive structure taken along section A-A. The configuration depicted in FIG. 2B is similar to the example described above with respect to FIG. 2A except that the array of upper electrodes 211 are disposed on a lower surface of the display 240 (instead of the upper substrate). The operation of the force-sensing structure 200b is substantially similar to the example described above with respect to FIG. 2A. Thus, the force-sensing structure 200b may be used to detect and measure the force of one or more touches on the cover glass 202.

In FIG. 2B, because the array of upper electrodes 211 are disposed on a lower surface of the display 240 instead of a separate substrate layer, the overall thickness of the stack may be reduced. Alternatively, the upper electrodes 211 may be disposed on another layer of the stack, such as a polarizer or other functional layer. As a further alternative, the array of upper electrodes 211 may be integrated with or integrally formed into another layer of the stack. For example, the array of upper electrodes 211 may be shared or integrated with the electrodes of a touch sensor layer or other electrical layer.

FIG. 2C depicts a cross-sectional view of the device of FIG. 1 having a third example force-sensitive structure taken along section A-A. In this example, the force-sensing structure 200c is disposed between the cover glass 202 and the display 240. Because the force-sensing structure 200c is disposed over the viewable area of the display 240, the structure may be formed using optically transparent materials. For example, the upper substrate 210 and lower substrate 220 may be formed from transparent materials, including, without limitation, glass or transparent polymers like polyethylene terephthalate (PET) or cyclo-olefin polymer (COP). The array of electrodes 211, 212 may also be formed from transparent conductive materials, including, for example, indium tin oxide (ITO), polyethyleneioxythiophene (PEDOT), carbon nanotubes, graphene, silver nanowire, other metallic nanowires, and the like. In some cases, the transparent conductive material may include another type of metal oxide material, including, for example, SnO2, In2O3, ZnO, Ga2O3, and CdO. Similarly, the compliant layer or medium may be formed from a transparent material, such as a transparent silicone gel or transparent liquid. In some cases, the compliant layer or medium is formed from a material having an optical index that is substantially matched to the optical index of the substrate and/or the electrodes of the force-sensing structure.

In the configuration depicted in FIG. 2C, a force that is applied to the cover glass 202 may cause a deflection in the upper substrate 210 relative to the lower substrate 220. Similar to the examples described above, the compliant medium 230 may displace near the location of the touch and allow for a localized deflection between the upper substrate 210 and the lower substrate 220. The compliant medium 230 may also distribute the load between the substrates, resulting in a gross or large area deflection of the lower substrate 220. As described above, the relative changes in the deflection of the substrates may be detected by measuring the changes in capacitance between the electrode pairs.

As shown in FIG. 2C, the stack is primarily supported by the cover glass 202. In this example, the cover glass 202 is supported along the perimeter by the mounting features 204c. Similar to the example described above with respect to FIG. 2A, the force-sensing structure 200c is suspended by the upper surface of the upper substrate 210. Similar to as described above, one advantage to this configuration is that the second, lower substrate 220 is allowed to deflect, which may enhance or improve the force-sensing capabilities of the force-sensing structure 200c as compared to some examples where the lower substrate is fully supported. While, in this example, the second substrate 220 is attached to polarizer 244 and display 240, the second substrate 220 may still deflect when a force is applied to the cover glass 202.

FIG. 2D depicts a cross-sectional view of the device of FIG. 1 having a fourth example force-sensitive structure taken along section A-A. In the example depicted in FIG. 2D, the force-sensing structure 200a is fully supported by the mounting feature 204d. In particular, the mounting feature 204b is formed as a continuous surface that supports the second or lower substrate 220 of the force-sensing structure 200d.

The example configuration depicted in FIG. 2D may be used to detect and measure the force of one or more touches on the surface of the cover glass 202. Similar to the examples described above, a force may be transmitted through the cover glass 202, display 240, and various other layers of the stack resulting in a predictable deflection. The force also may cause the first substrate 210 of the force-sensitive structure 200b to deflect relative to a second substrate 220. As described in the previous example, the first and second substrates 210, 220 are separated by a gap that may be substantially filled with a compliant medium 230, which may be configured to displace or flow to allow for localized deflection between the first and second substrates 210, 220. A portion of the first substrate 210 that is near the force applied by the touch may deflect relative to the second substrate 220 over a localized region or area. The relative deflection over the localized region may be greater than the relative deflection between the substrates over other portions of the force-sensing structure 200d, which may be detected and measured as a change in capacitance between the upper and lower electrode arrays 211, 221.

In the example depicted in FIG. 2D, the lower substrate 220 is fully supported by the mounting feature 204b. As described above, localized deflection may still occur between the first substrate 210 and the second substrate 220 when a force is applied to the cover glass 202. However, because the lower substrate 220 is fully supported from below, the lower substrate may not deflect when the force is applied. As a result, the relative deflection between the upper and lower substrates 210, 220 may occur over a larger area and/or be less distinct, as compared to examples where the force-sensing structure is not supported from below.

While the examples provided above with respect to FIGS. 2A-D are described with respect to force-sensitive structure integrated with a cover glass and a display, other configurations may also be used. For example, in one embodiment, the upper (or lower) electrodes may be formed on an interior surface of a housing of the electronic device. For example, a force-sensitive structure may be integrated into a rear panel or portion of a hand-held electronic device and used to detect the force of a grip or touch on the rear panel or portion of the device.

FIG. 3A depicts an example array of electrode disposed on a substrate. As described in the examples above with respect to FIGS. 2A-D, the electrodes of a force-sensing structure may be arranged as a two-dimensional array. In the example depicted in FIG. 3, the electrodes 211a are formed as an array of rectilinear elements disposed on a substrate 210a. For example, each electrode 211a may be aligned vertically (or horizontally) with a respect to a column (or row) of another electrode 211a. While the electrodes 211a are shown as having a square shape, the electrodes may be formed from a variety of geometries, including, for example, curved or circular shapes. Additionally, while the electrodes 311 are arranged in a rectangular array, in alternative embodiments, the electrodes may be arranged in a radial, polar, or other type of pattern.

FIG. 3B depicts an alternative example of an array of electrodes disposed on a substrate. In the example depicted in FIG. 3B, the electrodes 211b and 221b are formed as strips of conductive material arranged in rows and columns. In this depiction, the lower electrodes 221b are disposed on a lower substrate 220b. The upper electrodes 211b may be similarly disposed on an upper substrate, which is omitted from this view for clarity.

The configuration depicted in FIG. 3B may be used to detect and measure the relative deflection in the substrates using changes in capacitance between the upper and lower electrodes 211b, 221b. In particular, a mutual capacitance at the intersection of the row and column electrodes may be measured using capacitive monitoring circuitry. In one example, a charge or electrical current may be selectively applied to each row (or column) of the array of electrodes, which may be referred to as the drive electrodes. In one example, the row (or column) electrodes may be driven in a predetermined sequence which is repeated over a regular interval. A response or charge accumulation may be detected or sensed on the column (or row) electrodes, which may be referred to as sense electrodes. The response or charge accumulation may correspond to the mutual capacitance at the intersection or overlap of the corresponding drive electrode and sense electrode. A variety of other electrode configurations may also be used.

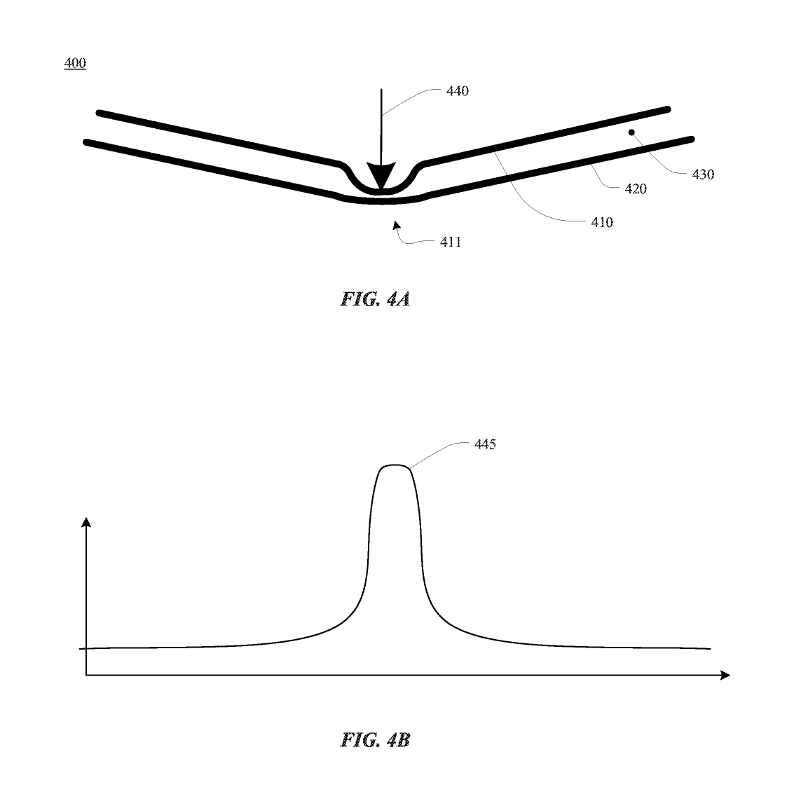

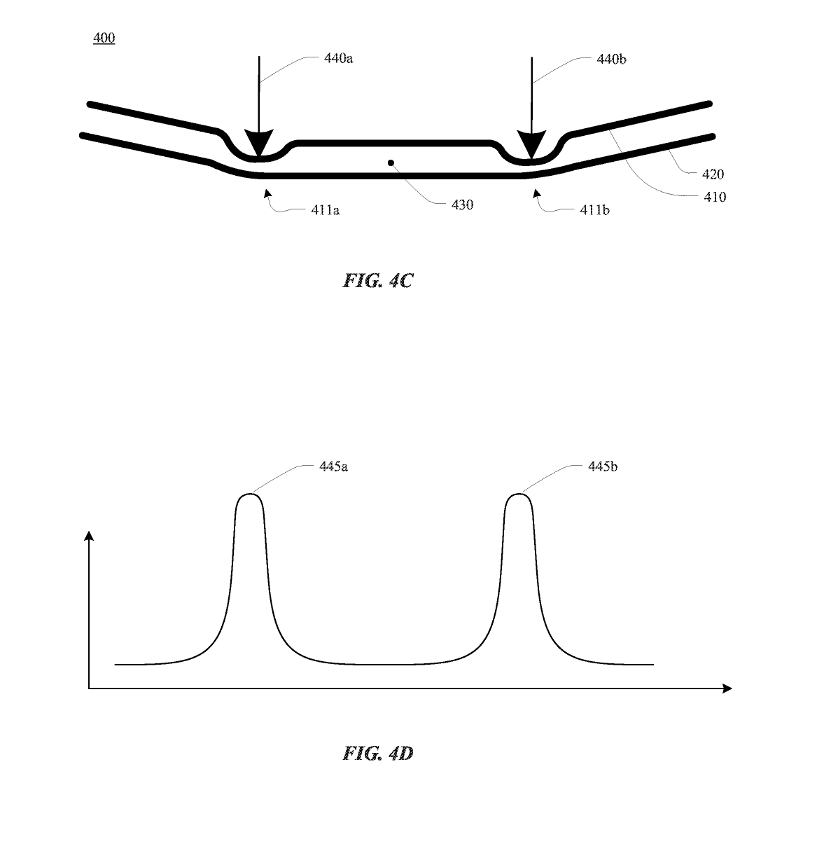

The mounting configuration and/or structural constraints placed on the force-sensitive structure may have an impact on the force-sensing capabilities of the force sensor. As previously described, the localized deflection may be more pronounced or distinct if a second or lower substrate is substantially unsupported and allowed to deflect in response to the applied force or forces. In particular, a substantially unsupported lower substrate may facilitate the formation of a substantially uniform gap between the substrates when subjected to a force or load. Thus, in some cases, it may be advantageous to suspend the force-sensitive structure, which may allow both upper and lower substrates to deflect in response to an applied force. FIGS. 4A-D depict an example force-sensitive structure in which the lower substrate is substantially unsupported from below, which may be accomplished by suspending the force-sensitive structure from the upper or first substrate.

FIG. 4A depicts an example force-sensitive structure 400 suspended from the first substrate 410 and subjected to an applied force. In this simplified example, a force 440 is applied relative to an upper substrate 410, which is separated by a gap from the lower substrate 420. A compliant layer or medium 430 is disposed in the gap between the upper substrate 410 and the lower substrate 420. FIG. 4A depicts an approximated deflection, which may be exaggerated to better illustrate the relative deflection between the substrates.

As shown in FIG. 4A, the force 440 due to, for example, a touch on a surface, may cause the first substrate 410 of the force-sensitive structure 400 to deflect relative to a second substrate 420. In particular, the first substrate 410 deflects relative to the second substrate 420 over a localized region 411. In this example, because the lower substrate 420 is substantially unsupported from below, the lower substrate 420 also deflects due to the force 440 applied to the upper substrate 410. In this case, the compliant medium 430 may help to maintain a substantially uniform gap or distance between the upper and lower substrates 420, 410 for portions of the force-sensitive structure 400 that are located away from the force 440. While the compliant medium 430 helps to maintain the gap over a wide area, the compliant medium 430 is also configured to displace or flow to allow deflection between the first and second substrates 410, 420 over the localized region 411. Thus, in some cases, a portion of the first substrate 410 that is near the force applied by the touch may deflect relative to the second substrate 420 over a localized region or area while, over the remainder of the structure, the first and second substrates 410, 420 remain separated by a substantially uniform gap. In this case, the relative deflection over the localized region may be greater than the relative deflection between the substrates over other portions of the force-sensing structure 400.

As described with respect to previous examples, the relative deflection at various locations between the substrates may be detected and quantified by measuring the capacitance between electrodes disposed on the upper substrate 410 and lower substrate 420, respectively. FIG. 4B depicts an example output of the force-sensitive structure 400, which may correspond to the relative capacitance of the electrodes disposed on the substrates. As shown in FIG. 4B, the electrical response of the force-sensitive structure 400 may have a pronounced peak 445 that corresponds to the localized deflection near the applied force (440 of FIG. 4A). Also, as shown in FIG. 4B, the electrical response is substantially constant or uniform for regions of the force-sensitive structure that are located away from the force (440 of FIG. 4A). In some implementations, the force (440 of FIG. 4A) may be estimated using the difference between the peak 445 and a reference value, such as the response of the structure at a location remote from the peak.

FIG. 4C depicts the same example force-sensitive structure 400 in deflection due to multiple applied forces. In this simplified example, a first force 440a is applied relative to the upper substrate 410 at a first location and a second force 440b is applied relative to the upper substrate at a second location. Similar to the previous example, FIG. 4C depicts an approximated deflection, which may be exaggerated to better illustrate the relative deflection between the substrates.

As shown in FIG. 4C, the applied force 440a results in a localized deflection of the first substrate 410 with respect to the second substrate 420 over the localized area 411a. Similarly, the applied force 440b results in another localized deflection of the first substrate 410 with respect to the second substrate 420 over the localized area 411b. For both localized areas 411a. 411b, the compliant medium 430 flows or displaces to allow for the localized deflection between the two substrates. The compliant medium 430 also helps to maintain a substantially uniform gap between the first and second substrate 410, 420 for the remaining portions of the force-sensitive structure 400.

FIG. 4D depicts an example output of the force-sensitive structure 400, which corresponds to the multi-touch example depicted in FIG. 4C. As in the previous example, the example output may correspond to the relative capacitance of the electrodes disposed on the substrates of the force-sensitive structure 400. As shown in FIG. 4D, the electrical response of the force-sensitive structure 400 may have two pronounced peaks 445a and 445b that correspond to the localized deflections near the applied forces (440a and 440b of FIG. 4C). Also, as shown in FIG. 4D, the electrical response is substantially constant or uniform for regions of the force-sensitive structure that are located away from the force (440a, 440b of FIG. 4C). In some implementations, both forces (440a, 44b of FIG. 4C) may be estimated using the difference between the corresponding peaks 445a, 445b and a reference value, such as the response of the structure at a location remote from the peak. In this way, multi-touch or multipoint force-sensing can be performed using a force-sensitive structure 400 as depicted in FIG. 4C.

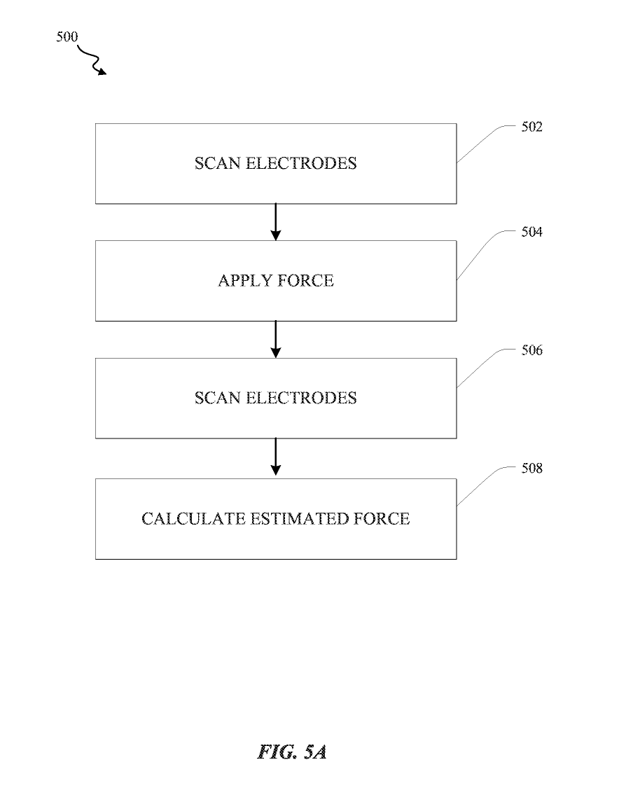

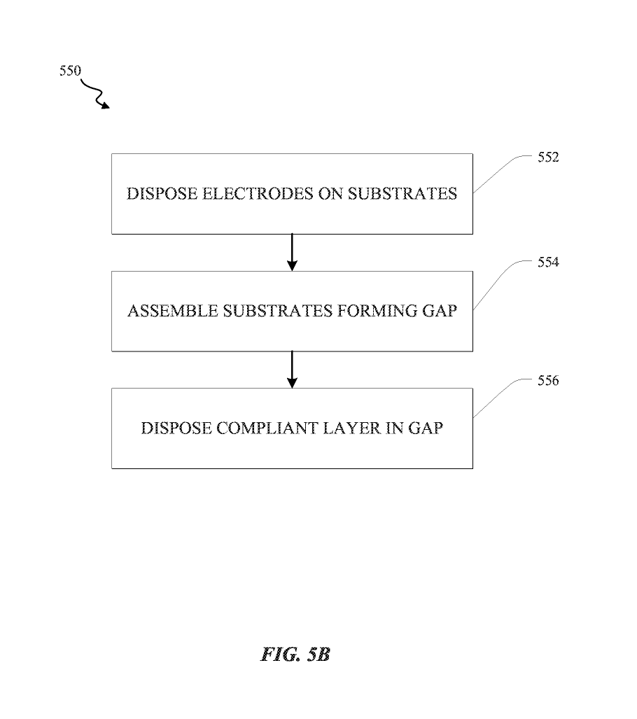

FIG. 5A depicts an example process 500 for detecting a touch using a force-sensitive structure. Process 500 may be used, for example, in conjunction with one of the force-sensitive structures described above with respect to FIGS. 2A-D. In particular, process 500 may be used to calculate an estimated force using a force-sensing structure that includes two substrates separated by a gap that may be substantially filled with a compliant material or layer. Electrodes disposed on the two substrates may be used monitor the capacitance between the electrodes.

In operation 502, an initial scan of the electrodes is conducted. In one example, the scan includes measuring the capacitance at each of the electrode pairs (or each of the electrode intersections). Operation 502 may be used to measure the state of the force-sensing structure with no force applied. The initial scan may be used to account for the effects of temperature or other ambient conditions of the force-sensing structure. Operation 502 maybe optional in some implementations.

In operation 504, a force is applied to the structure. The force may be caused by a touch on the surface of a device. As described above with respect to FIGS. 2A-D, the force may be applied to the force-sensing structure through multiple layers of a stack. In some cases, the force may be applied on a cover glass of a device and be transmitted to the force-sensing structure though the display and other elements.

In operation 506, a scan of the electrodes is conducted. In particular, the electrodes of the force-sensitive structure are scanned to measure the capacitance between the electrode pairs (or intersection of electrodes) while the force is being applied to the force-sensitive structure. In one example, all of the electrodes are scanned in operation 506. In another example, a subset of electrodes are scanned or sampled in operation 506. If the location of the touch is known (using, for example, a touch sensor), one or more electrodes that is near the touch location may be scanned and one or more electrodes that are located remote from the touch may be scanned. In some implementations, multiple scans are taken over a period of time to improve the reliability of the measurement.

In operation 508, and estimated force is calculated. In particular, the scan(s) of operation 506 may be used to estimate the distance between the respective electrodes. Typically, the force-sensitive structure deflects in a predictable fashion when the force is applied (in operation 504). Thus, if the distance between the electrodes (and substrates) are known, then an estimated force can be computed. In one example, the relative deflection (or capacitance), between a localized region of deflection and another region of the structure, is used to calculate an estimated force that is applied (in operation 504).

FIG. 5B depicts an example method of manufacturing a force-sensitive structure. Process 550 depicted in FIG. 5B may be used to manufacture one or more of the force-sensitive structures described above with respect to FIGS. 2A-D.

In operation 552, electrodes are disposed on each of the two substrates. The electrodes may be disposed using a deposition, printing, sputtering, lamination or other manufacturing process. In some cases, the electrodes are formed by treating a layer or layers to form conductive regions within a medium or layer. The medium or layer may be applied or otherwise attached to the surface of the substrate.

In operation 554, the two substrates are assembled to form a gap between the substrates. In one example, the substrates are assembled to one or more spacers or columns that are used to define the thickness of the gap between the substrates. The spacers or columns may be removed or may remain in place after construction of the force-sensitive structure is complete. In another example, the substrates are attached to or placed on opposite sides of the compliant layer, if the compliant layer is formed from a material has a sufficient structural integrity. (This may not be possible if the compliant layer is formed from a liquid or soft gel.)

In operation 556, a compliant layer is disposed within the gap between the two substrates. In some cases, the compliant layer is formed from a silicone gel or structure. In some cases, the compliant layer is formed from multiple structures or columns of material that are arranged within the gap. The space of volume between the structures or columns may be substantially filled with a liquid medium. In one example, a polyethylene glycol or polyglycol liquid is injected into the gap to substantially fill the volume between the two substrates. In some cases, a sealing layer or element is also used to keep the compliant layer in place.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

1-20. (canceled)

21. A force-sensitive structure for an electronic device, comprising:
a first substrate;
a first electrode disposed on the first substrate;
a second substrate separated from the first substrate by a gap;
a second electrode disposed on the second substrate; and
a compliant medium disposed within the gap, the compliant medium operative to displace as the first substrate deflects in response to a received force.

22. The force-sensitive structure of claim 21, further comprising capacitive monitoring circuitry coupled to the first electrode and the second electrode, the capacitive monitoring circuitry operative to determine a change in capacitance between the first electrode and the second electrode.

23. The force-sensitive structure of claim 22, wherein the first electrode is a drive electrode of the capacitive monitoring circuitry.

24. The force-sensitive structure of claim 22, wherein the second electrode is a drive electrode of the capacitive monitoring circuitry.

25. The force-sensitive structure of claim 22, wherein the capacitive monitoring circuitry is operative to produce an output corresponding to an amount of the received force.

26. The force-sensitive structure of claim 21, wherein the second substrate is operative to deflect relative to the deflection of the first substrate.

27. The force-sensitive structure of claim 21, wherein the first electrode is an array of electrodes.

28. The force-sensitive structure of claim 21, wherein the second electrode is an array of electrodes.

29. The force-sensitive structure of claim 21, wherein the compliant medium is a gel.

30. An electronic device, comprising:
a cover glass;
a display component; and
a force-sensitive structure comprising:
a first substrate;
at least a first electrode disposed on the first substrate;
a second substrate separated from the first substrate;
at least a second electrode disposed on the second substrate;
a compliant medium disposed between the first substrate and the second substrate; and
capacitive sensing circuitry coupled to the at least the first electrode and the at least the second electrode and operative to detect a change in capacitance between the at least the first electrode and the at least the second electrode as the first substrate deflects relative to the second substrate in response to a force provided on the cover glass.

31. The electronic device of claim 30, wherein the force-sensitive structure is suspended from the display component.

32. The electronic device of claim 30, wherein the force-sensitive structure is positioned above the display component.

33. The electronic device of claim 30, wherein the first substrate is part of the display component.

34. The electronic device of claim 30, wherein the at least the first electrode is a drive electrode of the capacitive sensing circuitry.

35. The electronic device of claim 30, wherein the at least the second electrode is a drive electrode of the capacitive sensing circuitry.

36. The electronic device of claim 30, wherein the compliant medium comprises a liquid.

37. An electronic device, comprising:
a display component comprising a force-receiving surface; and
a force-sensitive structure comprising:
a first substrate comprising an array of electrodes;
a second substrate comprising at least one electrode, the second substrate separated from the first substrate by a gap, wherein the first substrate is operative to deflect relative to the second substrate in response to a force provided on the force-receiving surface.

38. The electronic device of claim 37, further comprising capacitive monitoring circuitry coupled to the array of electrodes and the at least one electrode, the capacitive sensing circuitry operative to measure a change in capacitance between the array of electrodes and the at least one electrode when the first substrate deflects relative to the second substrate.

39. The electronic device of claim 37, further comprising a compliant medium disposed within the gap.

40. The electronic device of claim 39, wherein the compliant medium is displaced in response to the deflection of the first substrate.
